(19) United States
(12) Patent Application Publication
(10) Pub. No.: US 2012/0166853 A1
(43) Pub. Date: Jun. 28, 2012

(54) POWER SUPPLY SYSTEM CAPABLE OF AUTOMATICALLY ADJUSTING OPERATING VOLTAGE OF CPU

(75) Inventors: CHUANG-WEI TSENG, Tu-Cheng (TW); HO-FENG LIN, Tu-Cheng (TW)

(73) Assignee: HON HAI PRECISION INDUSTRY CO., LTD., Tu-Cheng (TW)

(21) Appl. No.: 13/077,915

(22) Filed: Mar. 31, 2011

(30) Foreign Application Priority Data
Dec. 28, 2010 (TW) 99146264

(51) Int. Cl. G06F 1/28

(52) U.S. Cl. 713/340

(57) ABSTRACT

An exemplary power supply system for a CPU, includes a power managing module and a computer system module. The power managing module supplies a current operating voltage to the CPU. The computer system module electrically communicates with the power managing module and the CPU, obtains a next operating voltage required in a next program carried out by the CPU, and controls the power managing module to adjust the current operating voltage to be the next operating voltage before the next program is carried out.

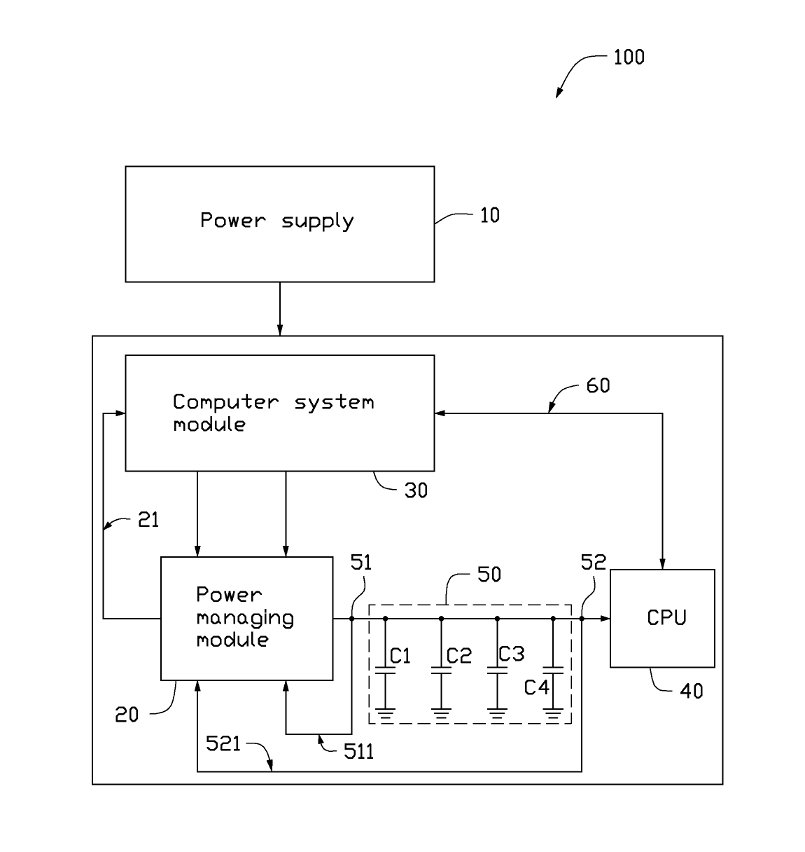

### BACKGROUND

1. Technical Field

The present disclosure relates to a power supply system, and more particularly, relates to a power supply system capable of automatically adjusting operating voltage supplied to a center processing unit (CPU).

2. Description of Related Art

Overshoot and undershoot voltages usually occurs in a power supply circuit that supplies operating voltage to a CPU of a computer system. As a result, the computer is unstable, and at worst, the CPU malfunctions. Therefore, providing a power supply system to ensure stability of the computer system is desired.

### BRIEF DESCRIPTION OF THE DRAWING

Many aspects of the present disclosure can be better understood with reference to the following drawing. The components in the drawings are not necessarily drawn to scale, the emphasis instead being placed upon clearly illustrating the principles of the present disclosure.

The FIGURE shows the principle of a power supply system according to an exemplary embodiment of the present disclosure.

### DETAILED DESCRIPTION

Embodiments of the present power supply system will now be described in detail and with reference to the drawing.

The FIGURE shows the principle of a power supply system 10 according to an exemplary embodiment of the present disclosure. The power supply system 100 supplies an operating voltage to a CPU 40, and includes a power supply 10, a power managing module 20, a computer system module 30, and a voltage stabilizing circuit 50.

The power supply 10 is configured for rectifying an external electrical power to an adaptable voltage suitable for the power managing module 20, the computer system module 30 and the CPU 40. For instance, the power supply 10 can rectify 220V alternating current to 15V direct current.

The power managing module 20 is configured for distributing the voltage rectified by the power supply 10 to the computer system module 30 and the CPU 40. Herein, the voltage distributed on the CPU 40 is defined as the operating voltage. The voltage stabilizing circuit 50 electrically communicates with an output port of the power managing module 20 and an input port of the CPU 40, and includes four capacitors C1, C2, C3 and C4 in parallel connection with each other, an input port 51 and an output port 52. The input port 51 electrically connects with the power managing module 20, forming a current feedback path 511. The output port 52 electrically connects with the power managing module 20, forming a voltage feedback path 521. The power managing module 20 supplies stable voltage to the CPU 40 via the current feedback path 511 and the voltage feedback path 521.

The computer system module 30 controls output voltage of the power managing module 20 according to the load status of the CPU 40. The computer system module 30 continuously electrically communicates with the CPU 40 via a fieldbus 60 to obtain the operating voltage of the CPU required for carrying out a next program, analyzes whether the current voltage on the CPU 40 is equal to the required operating voltage, and sends a corresponding adjusting instruction to the power managing module 20. As such, the power managing module 20 can adjust its output voltage to be the required operating voltage. In detail, when obtaining the load of the CPU 40 increases, the computer system module 30 sends a compensative instruction to the power managing module 20, and the current voltage is increased to the required operating voltage before the next program is carried out, thereby avoiding undershoot. When obtaining the load of the CPU 40 decreases, the computer system module 30 sends a step-down instruction to the power managing module 20, and the current voltage is adjusted to be the required operating voltage, thereby avoiding overshoot.

A power good feedback path 21 is further included. The power good feedback path 21 electrically interconnects with the power managing module 20 and the computer system module 30, and is configured for notifying the computer system module 30 whether the voltage supplied by the power managing module 20 is in a normal status. In this manner, the computer system module 30 decides whether to operate a corresponding the computer system.

The described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A power supply system for a central processing unit (CPU), comprising:
a power managing module that supplies a current operating voltage to the CPU; and
a computer system module electrically communicating with the power managing module and the CPU, the computer system module configured for obtaining a next operating voltage required in a next program carried out by the CPU, and controlling the power managing module to adjust the current operating voltage to be the next operating voltage before the next program is carried out.

2. The power supply system of claim 1, further comprising a power supply for rectifying an external alternating electrical power to an adaptable direct voltage suitable for the power managing module and the CPU.

3. The power supply system of claim 1, wherein the computer system module electrically communicates with the power managing module by sending a compensative instruction or a step-down instruction to the power managing module.

4. The power supply system of claim 1, further comprising a voltage stabilizing circuit interconnecting with the power managing module and the CPU, the voltage stabilizing circuit configured for supplying the CPU a stable operating voltage.

5. The power supply system of claim 4, wherein the voltage stabilizing circuit comprises four capacitors which are in parallel connection with each other.

6. The power supply system of claim 4, further comprising a current feedback path and a voltage feedback path, the current feedback path and the voltage feedback path each electrically interconnected with the power managing module and the CPU.

7. The power supply system of claim 1, further comprising a power good feedback path electrically interconnecting with the power managing module and the computer system module, the power good feedback path being configured for notifying the computer system module whether the voltage supplied by the power managing module is in a normal status.
